(19) United States
(12) Patent Application Publication
(10) Pub. No.: US 2014/0008269 A1
(43) Pub. Date: Jan. 9, 2014

(54) REACTOR FOR CONTINUOUS CATALYST REGENERATION WITH A GAS DISTRIBUTION TRAY IN THE OXYCHLORINATION ZONE

(71) Applicant: IFP Energies nouvelles, Rueil-Malmaison Cedex (FR)

(72) Inventors: Cecile PLAIS, Les Haies (FR); Frederic BAZER-BACHI, Irigny (FR); Fabian LAMBERT, Chatou (FR); Thierry LEFLOUR, Paris (FR); Xavier DECOODT, Carrieres S/Seine (FR)

(21) Appl. No.: 13/932,050

(22) Filed: Jul. 1, 2013

(30) Foreign Application Priority Data
Jul. 4, 2012 (FR) 12/01888

(51) Int. Cl. B01J 38/44

(52) U.S. Cl. CPC B01J 38/44
USPC 208/134; 422/606; 29/402.08

(57) ABSTRACT

The reactor 1 that allows continuous regeneration of the catalyst consists of a chamber 2 that comprises an oxychlorination zone superposed on a calcination zone equipped with a pipe for introducing calcination gas 76. A mixing zone 74 is arranged between the oxychlorination zone 72 and the calcination zone 75. The mixing zone 74 is covered by a tray 80 through which a number of tubes 81 pass, making it possible for the catalyst to pass from the oxychlorination zone 72 into the calcination zone 75. The tubes 81 extend vertically at least over the height H of the mixing zone 74. One or more pipes 73 for injecting oxychlorination gas empties/empty into the mixing zone. The tray 80 comprises a number of openings for distributing the gas from the mixing zone 74 into the oxychlorination zone 72 in a homogeneous manner.

This invention relates to the field of the conversion of hydrocarbons and more specifically of the reforming of hydrocarbon-containing feedstocks in the presence of a moving-bed catalyst for producing gasoline fractions. This invention proposes a catalyst regeneration reactor with a tray for mixing the calcination gas and the oxychlorination gas and for distributing the gas in the oxychlorination zone of the catalyst.

The processes for catalytic reforming of gasolines operating in a moving bed generally implement a reaction zone that can comprise three or four reactors in a series and a catalyst regeneration zone that implements a certain number of stages, in general a combustion stage, an oxychlorination stage, followed by a calcination stage and a reduction stage. The document U.S. Pat. No. 3,761,390 describes a sample embodiment of a catalytic reforming process operating in a moving bed.

The document U.S. Pat. No. 7,985,381 describes in detail a regeneration reactor that comprises a combustion zone, an oxychlorination zone, and a calcination zone. The catalyst circulates in a downward vertical direction in the reactor. It passes from the oxychlorination zone to the calcination zone via an annular ring. A calcination gas that is injected at the bottom of the calcination zone passes through, in countercurrent, the catalyst bed in the calcination zone and then is recovered in a second annular zone located on the periphery of the reactor. In this second annular zone, the oxychlorination gas is injected to be mixed with the calcination gas that has been recovered. The gas mixture is then injected on the periphery of the reactor at the bottom of the oxychlorination zone.

The injection of this gas mixture on the periphery of the reactor has the drawback of generating a speed profile of the non-homogeneous gas at the outlet of the injection zone on the cross-section of the oxychlorination zone. In addition, the passage of the catalyst from the oxychlorination zone to the calcination zone via an annular ring is cumbersome in the reactor and generates pressure drops. Nevertheless, the pressure drops are not sufficient to prevent calcination gas from rising directly via the downward legs of the catalyst without passing into the external annular ring and therefore without being mixed with the calcination gas.

This invention proposes to optimize the distribution of the gas mixture that is injected into the oxychlorination zone by means of a mixing zone that is equipped with a tray that makes it possible in particular to distribute the gas mixture in a homogeneous manner over the cross-section of the reactor.

In a general manner, this invention describes a reactor for continuous regeneration of catalyst grains, composed of a chamber that comprises an oxychlorination zone superposed on a calcination zone that is equipped with a pipe for introducing calcination gas. The reactor is characterized in that the oxychlorination zone is separated by a height H from the calcination zone by a mixing zone that extends over said height H, with the mixing zone being covered by a tray through which a number of tubes pass, making it possible for the catalyst grains to pass from the oxychlorination zone into the calcination zone, with the tubes extending at least over the height H of the mixing zone, the lower surface of the mixing zone being gas-permeable. The reactor also comprises a pipe for injecting oxychlorination gas emptying into the mixing zone. The plate comprises a number of openings that are permeable to gas and impermeable to catalyst grains.

According to the invention, each of the openings can be selected from among a bubble cap, a perforated plate, or a grid.

Each of the openings can be composed of a vertical tubular grid, with the lower end of the tubular grid communicating with the mixing zone, and the upper end of the grid being blocked by a roof.

The roof can be a cone whose peak is directed upward.

The pipe for injecting oxychlorination gas can empty into the mixing zone at the wall of the chamber of the reactor.

The pipe for injecting oxychlorination gas can empty into the middle of the mixing zone.

The mixing zone can comprise at least one deflecting plate that is arranged in front of the pipe for injecting oxychlorination gas.

The lower surface of the mixing zone can comprise a gas-permeable plate.

The tubes can be integral with the tray and the gas-permeable plate.

The reactor according to the invention can be used in a process for catalytic reforming of a hydrocarbon feedstock, in which
A stream of catalyst grains is introduced at the top of the oxychlorination zone,
A stream of calcination gas is introduced via the pipe for introducing calcination gas,
A stream of oxychlorination gas is introduced via the pipe for injecting oxychlorination gas,
A stream of gas is evacuated at the top of the oxychlorination zone,
A stream of catalyst grains is evacuated at the bottom of the calcination zone.

The catalyst grains can comprise platinum deposited on a porous substrate, the stream of calcination gas can comprise air or depleted air and can be at a temperature of between 400° C. and 550° C., and the stream of oxychlorination gas can comprise a chlorinated compound and can be at a temperature of between 350° C. and 550° C.

It is possible to carry out a remodeling of a reactor that exists by replacing the old oxychlorination gas injection system by said mixing zone according to the invention.

According to the invention, the fact of mixing the calcination gas with the oxychlorination gas in the mixing space that is lacking in catalyst grain makes it possible to obtain a good gas mixture.

In addition, the multiplication of the gas injection points by the openings on the cross-section of the reactor makes possible an excellent distribution of the gas mixture over the entire cross-section of the reactor.

Furthermore, the passage of catalyst grains from the oxychlorination zone to the calcination zone via tubes makes it possible to minimize the passage of gas directly from the calcination zone to the oxychlorination zone without passing through the mixing zone.

In addition, this invention can be easily implemented in existing installations. In particular, this invention can advantageously replace an oxychlorination gas injection device so as to improve its mixing and distribution performances.

Other characteristics and advantages of the invention will be better understood and will appear clearly from reading the description given below by referring to the drawings, among which:

### BRIEF DESCRIPTION OF THE DRAWINGS

FIG. 1 shows a catalyst regeneration reactor,

FIG. 2 shows in perspective an embodiment of the mixing zone according to the invention,

FIG. 3 shows a second embodiment of the mixing zone according to the invention,

FIG. 4 shows in detail an embodiment of a gas passage opening of the distributor tray according to the invention,

FIG. 5 shows a cutaway of FIG. 3.

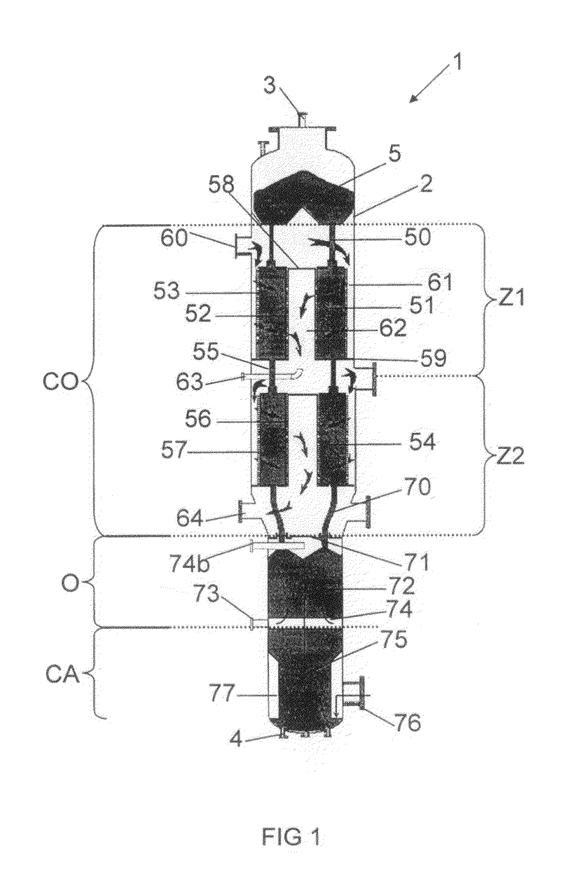

In FIG. 1, the catalyst regeneration reactor consists of a chamber 2 that contains a combustion zone CO, an oxychlorination zone O, and a calcination zone CA. The chamber 2 can be in the form of a vertical axis cylinder, with the cylinder being closed at its ends. The zones for combustion, oxychlorination, and calcination are superposed in the reactor 1. In the reactor 1, these zones can have the same diameter or different diameters.

The catalyst that is to be regenerated is introduced at the top of the reactor 1 by the pipe(s) 3 and is evacuated from the reactor 1 via the pipes 4 that are located at the bottom of the reactor 1. Under the effect of gravity, the catalyst circulates from top to bottom in the reactor by successively passing through the zones for combustion CO, oxychlorination o, and calcination CA. The catalyst is evacuated from the reactor 1 at the bottom of the calcination zone CA via the pipes 4. The reactor 1 is continuously supplied with catalyst, and the catalyst circulates continuously in the reactor 1.

The catalyst is in the form of solid grain, for example in ball form having between 0.5 and 20 mm in diameter so as to facilitate the circulation of the catalyst in the reactor 1. The catalyst grains consist of a porous substrate, for example an alumina, on which different compounds—in particular platinum and chlorine, and optionally tin, rhenium, indium and/or phosphorus—have been deposited. The catalyst that is to be regenerated comprises coke, for example approximately 5% by weight of coke.

The catalyst that is introduced by the pipe 3 into the reactor 1 arrives in a tank 5 that is equipped with a hopper that makes it possible to supply the combustion zone CO with catalyst.

The combustion zone CO has as its object to carry out the combustion of the coke deposited on the catalyst. The zone CO can comprise one or more stages. The reactor 1 of FIG. 1 comprises two stages Z1 and Z2. According to a particular embodiment, the combustion zone can also comprise a combustion monitoring zone, for example as described by the document FR 2761907. The catalyst of the tank 5 is introduced into an annular space 51 of stage Z1 via the feed pipes 50. The annular space 51 is delimited by two tubular grids 52 and 53, for example cylindrical and concentric. The space 61 that is located between the tubular grid 53 and the chamber 2 is blocked at its lower end by the plate 59. The space 61 can be arranged in the form of a portion commonly named “scallops.” The central space 62 that is located inside the tubular grid 52 is blocked at its upper end by the plate 58. The catalyst of the annular space 51 is introduced into an annular space 54 of stage Z2 via the feed pipes 55. The space 54 is delimited by two tubular grids 56 and 57, for example cylindrical and concentric. The grids 52, 53, 56 and 57 make it possible to retain the catalyst while allowing gas to pass. For example, the grids 52, 53, 56 and 57 can be Johnson grids and/or perforated plates.

A first stream of combustion gas containing oxygen is introduced into the chamber 2 at the top of stage Z1 by the opening 60. In stage Z1, the stream of gas circulates according to the arrows that are indicated in FIG. 1 by passing through the catalyst bed contained in the annular space 51. Actually, the airtight plates 58 and 59 force the combustion gas coming in via the opening 60 to pass from the space 61 onto the periphery of the annular space 51 to the central space 62 located inside the grid 52 by passing through the catalyst into the annular space 51. A second stream of combustion gas containing oxygen is introduced between stages Z1 and Z2 via the pipe 63. This second stream mixes with the first gas stream that has passed through stage Z1. In the same way as for stage Z2, the combustion gas passes through the catalyst bed contained in the annular space 54, according to the arrows that are indicated in FIG. 1. After having passed through the catalyst of zone 54, the combustion gas is evacuated from stage Z2 via the pipe 64.

According to another embodiment, the combustion zone CO can be arranged in such a way that the combustion gas circulates from the inside to the outside into the annular spaces 51 and 54. In addition, alternatively, according to another embodiment, the combustion zone can be arranged in such a way that the movement of the gas is injected at the bottom of the zone CO and is evacuated at the top of the zone CO.

The catalyst in the annular zone 54 of the combustion zone flows from the combustion zone CO into the oxychlorination zone O via the pipes 70. The plate 71 that is arranged between the combustion zone and the oxychlorination zone O is gas-tight to prevent the circulation of gas between these two zones.

In particular, the oxychlorination zone O has as its object to recharge the catalyst grains with chlorine and to redisperse the platinum on its surface so as to improve the distribution of the platinum in the catalyst grains. In the oxychlorination zone O, the catalyst flows into the space 72 inside the reactor, for example the cylindrical space defined by the walls of the chamber 2 of the reactor. The bottom of the space 72 of the oxychlorination zone O is equipped with the pipe 73 that makes it possible to inject the oxychlorination gas into the oxychlorination zone. The oxychlorination gas comprises a chlorine-containing compound and can be at a temperature of between 350° C. and 550° C., preferably between 460° C. and 530° C. At the top of the space 72, the pipe 74b makes it possible to evacuate the gas from the oxychlorination zone O. The oxychlorination gas that is injected via the pipe 73 circulates in an upward direction through the space 72, in countercurrent to the gravity flow of the catalyst. Then, the gas that has passed through the space 72 is evacuated from the chamber 2 via the pipe 74b.

The catalyst that comes in at the bottom of the oxychlorination zone O continues to flow from the space 72 to the space 75 of the calcination zone CA. The calcination zone in particular has as its object to dry the catalyst grains. The bottom of the calcination zone CA is equipped with the pipe 76 that makes it possible to inject the calcination gas at the bottom of the space 75. The calcination gas comprises air or oxygen-depleted air and can be at a temperature of between 400° C. and 550° C. So as to distribute in a homogeneous manner the calcination gas in the space 75, the pipe 76 can empty into an annular space 77 that is arranged on the periphery, between the space 75 and the chamber 2. The annular space 77 is open in its lower part located at the bottom of the space 75 of the calcination zone CA. Thus, the gas that is injected via the pipe 76 is distributed in the catalyst bed over the entire periphery at the bottom of the space 75. The calcination gas that is injected via the pipe 76 circulates in an upward direction, in counter-current to the gravity flow of the catalyst, through the space 75, and then through the space 72. When the calcined gas passes from the space 75 to the space 72, it encounters—and mixes with—the oxychlorination gas that is injected via the pipe 73. Then, the gas that has passed through the space 72 is evacuated from the chamber 2 via the pipe 74b.

According to the invention, a mixing zone 74 is arranged between the space 72 and the space 75. The mixing zone 74 comprises a distributor tray that is designed so as to carry out a homogeneous mixing of the calcination gas with the oxychlorination gas and to distribute in a homogeneous manner the gas mixture over the entire cross-section of the space 72.

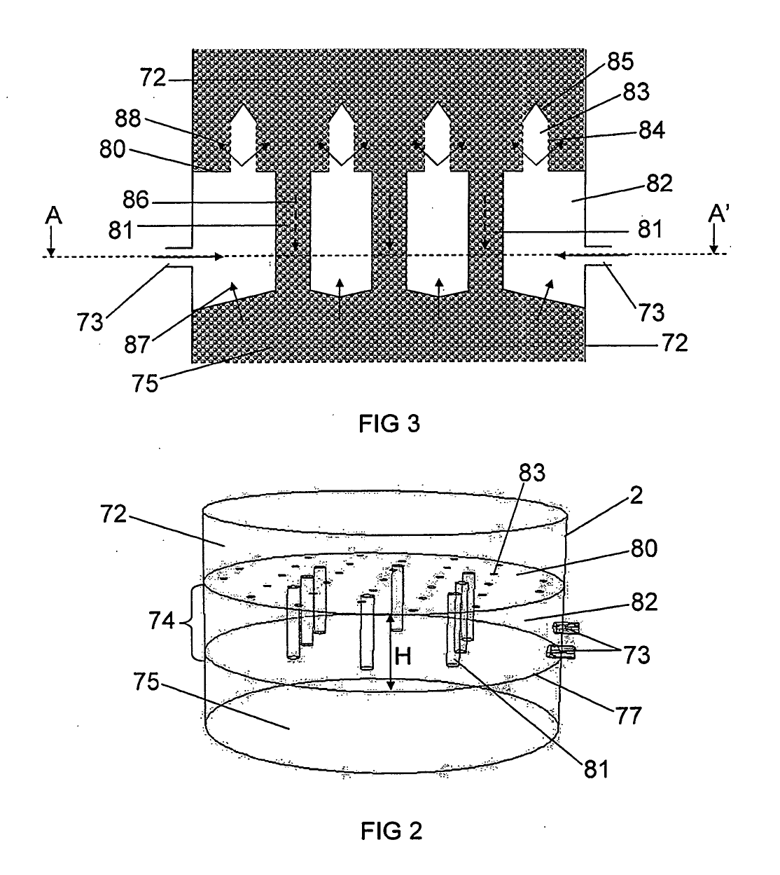

The mixing zone 74 is described in detail with reference to FIG. 2. The references of FIG. 2 that are identical to those of FIG. 1 refer to the same elements.

With reference to FIG. 2, the mixing zone 74 is positioned between the space 72 of the oxychlorination zone and the space 75 of the calcination zone. The mixing zone 74 is covered by a tray 80. The tray 80 is a gas-tight plate that does not allow the catalyst grains to pass. For example, the tray 80 is a solid disk with a cross-section that is equal to the cross-section of the chamber 2. Alternatively, the tray 80 can be wavy, for example by forming cones or funnels around tubes 81 described below.

Several tubes 81, which make possible the flow of catalyst grains from the space 72 of the oxychlorination zone up to the space 75 of the calcination zone, pass through the tray 80. The tubes 81 extend under the tray 80 over a height H. The number, the position, the cross-section and/or the height H of the tubes 81 are determined to ensure that the catalyst flow passes from the space 72 to the space 75. For example, the cumulative cross-section of tubes 81 is preferably greater than or equal to the cross-section of pipes 4 for draining the catalyst at the bottom of the reactor 1, with the cross-sections being made along a horizontal cutaway. For example, the tubes 81 can be cylindrical tubes with a diameter that varies between 1″ (2.54 mm) and 4″ (10.16 mm) and with a height H that varies between 50 mm and 500 mm. The passage of the catalyst grains from the oxychlorination zone to the calcination zone via tubes 81 makes it possible to minimize the passage of gas directly through these tubes without passing into the mixing space 82. In addition, the sizing parameters of the tubes can be determined for minimizing the amount of calcination gas rising from the space 72 to the space 75 through the tubes 81. To do this, the total number of tubes can be between 4 and 20, preferably between 4 and 16, with the minimum diameter of the tubes being determined for preventing the blocking of catalyst grains in the tubes. Furthermore, the ratio between the cumulative cross-section of the tubes and the surface of the tray 80 can be between 0.2 and 5%, preferably between 0.5 and 2%, with the cumulative cross-section and the surface of the tray 80 being measured along a horizontal plane.

The tray 80 that is combined with the tubes 81 makes it possible to delimit a mixing space 82 located under the tray 80 between the tubes 81. The mixing space 82 extends over the height H of the tubes 81. Actually, the tray 80 combined with the tubes 81 makes it possible to prevent the presence of catalyst in the mixing space 82 under the tray 80 over the height H. The tubes 81 can be essentially vertical. For example, the axes of the tubes 81 form an angle of between 0° and 15° relative to the vertical direction. The pipes 73 emptying out through the chamber 2 into the mixing space 82 make it possible to introduce oxychlorination gas into the mixing space 82. The lower cross-section 77 of the mixing space 82 allows gas to pass. For example, the lower cross-section 77 is open. Thus, the calcination gas that circulates in an upward vertical direction into the space 75 empties into the mixing space 82. Thus, the mixing of the calcination gas with the oxychlorination gas in the mixing space 82 that is lacking in catalyst grain is carried out, which makes it possible to obtain a good gas mixture. In addition, the pipe 73 can constitute a lateral gas intake in the mixing space, i.e., the pipe 73 can be horizontal and passes through the chamber 2. Consequently, the gas stream that is injected via the pipe 73 can be essentially horizontal through the chamber 2. The fact of injecting the oxychlorination gas in a lateral manner via the horizontal pipe 73 makes it possible to carry out an excellent mixing with the calcination gas circulating in cross-current relative to the oxychlorination gas that is injected horizontally via the pipe 73. Alternatively, the pipe 73 can be arranged to empty into the middle of the mixing space 82. For example, the pipe 73 can pass above, below or through the mixing zone 74. This configuration makes it possible to inject the oxychlorination gas into the middle of the mixing space 82 so that it can be distributed in a homogeneous manner within the entire mixing space 82.

With reference to FIG. 2, the lower surface of the mixing space 82, i.e., the interface between the mixing zone 74 and the calcination zone CA, is open. Alternatively, it is possible to arrange a gas-permeable plate 77 over the lower surface of the mixing space 82. The plate 77, for example a grid or a perforated plate, allows gas to pass from the space 75 of the calcination zone into the mixing space 82. In this case, the tubes 81 pass through the plate 77 for creating a passage of the catalyst grains communicating between the space 72 and the space 75. The grid or perforated plate makes it possible to introduce the oxychlorination gas at high speed without entraining solid particles of the catalyst bed from the space 75 into the mixing zone. In addition, the plate 77 can reinforce the mechanical behavior of the tray 80 by making the tubes integral with, on the one hand, the plate 77, and, on the other hand, the tray 80.

The tray 80 comprises a number of openings 83 that make it possible for gas to pass from the mixing space 82 into the space 72 of the oxychlorination zone. The openings are sized to allow gas to pass while preventing catalyst grains from passing. The multiplication of the gas injection points via the openings 83 over the cross-section of the reactor makes possible an excellent distribution of the gas mixture over the entire cross-section of the reactor, a distribution that can be faster than that relative to an intake in an external ring as presented by the document U.S. Pat. No. 7,985,381. Of course, the openings 83 are positioned on the tray 80 with separate locations of the tubes 81.

For example, the openings 83 can be equipped with a grid, a device commonly named “bubble cap,” or any other system allowing gas and not catalyst grains to pass.

For example, it is possible to use the opening 83 shown in diagram form by FIG. 3. The references of FIG. 3 that are identical to the one of FIG. 2 refer to the same elements. With reference to FIG. 3, the opening 83 consists of a cylinder 84 in a grid, for example a Johnson grid, covered by a solid plate 85. The lower end of the cylinder 84 communicates with the mixing space 82, while the upper end of the cylinder 84 is blocked by the plate 85 that forms a roof. The cylinder 84 extends along a vertical axis to promote the flow of catalyst grains along the grid and to prevent the blocking and the deposition of fragments, also named “fines,” of catalyst against the grid. The roof 85 can be cone-shaped so as to divert the flow of catalyst around the grid 84. For example, the diameter of the cylinders 84 can be between 0.5″ (1.27 mm) and 5″ (12.7 mm), preferably between 0.5 (1.27 mm) and 3″ (7.62 mm), and the height of the cylinders 84 can be between 50 and 400 mm, preferably between 100 and 250 mm.

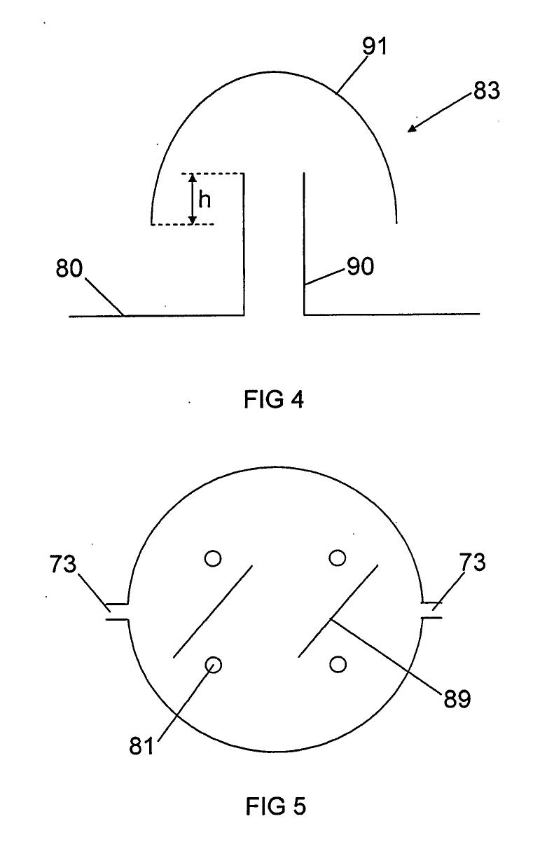

For example, it is possible to use the opening 83, of “bubble cap” type shown in a diagram by FIG. 4. The “bubble cap” opening consists of a vertical shaft 90 covered by a cap 91. The shaft 90 is a tube that passes through the tray 80 and that extends above the tray 80. The cap 91 can be dome-shaped, cone-shaped or cylindrical and covers at least the entire cross-section of the shaft 90. The cap 91 is arranged relative to the shaft 90 in such a way that the low end of the cap 91 is lower than the upper end of the shaft 90 so as to prevent catalyst grains from passing through the shaft 90. For example, the upper end of the shaft 90 exceeds the lower end of the cap 91 by at least one height h. In addition, the cap 91 can reach the tray 80, with openings or gaps then being hollowed out at the ends of the cap so as to allow gas to pass.

FIG. 5 shows a cutaway along the axis AA′ of the mixing zone 82 of FIG. 3. To improve the mixing of gas in the space 82, it is possible to arrange inside elements 89 in the mixing space 82, for example deflecting plates, which break up the jets of oxychlorination gas injected through the openings 73 and which promote the mixing with the calcination gas. Without exceeding the scope of the invention, it is also possible to use deflecting plates when the pipe 73 empties into the center of the space 82.

The operation of the mixing zone according to the invention is described with reference to FIG. 3. In FIG. 3, the space that is occupied by the catalyst is shown with crosshatching on the surface. The catalyst flows from the space 72 into the space 75 via the tubes 81 in the direction of the arrows 86. The calcination gas that circulates in the space 75 is recovered in the mixing space 82 according to the referenced arrows 87. In the mixing space 82, the calcination gas is mixed with the oxychlorination gas that comes in via the pipes 73. The gas mixture is evacuated via the openings 83 according to the referenced arrows 88. The openings 83 are distributed over the surface of the tray 80, for example in a uniform manner, and they make it possible to distribute the gas mixture in a uniform manner over the cross-section of the space 72 of the oxychlorination zone. For example, the openings can be arranged in such a way that the distance separating two tubes is between 50 and 400 mm, preferably between 100 and 250 mm.

The simplicity of the mixing zone 74 and the reduced dimensions of the mixing zone 74, in particular the small height requirement relative to the size of the reactor, make it possible to use the mixing zone according to the invention within the framework of a remodeling, commonly called “revamping,” of an installation. Actually, it is possible to install the tray 80 that is equipped with openings 83 and tubes 81 and an injection pipe 73 in place of another system in an existing reactor, for example a reactor that is described by the document U.S. Pat. No. 7,985,381.

Thus, the mixing zone 74 that is equipped with the tray 80 makes it possible to carry out a homogeneous mixing between the calcination gas with the oxychlorination gas and makes it possible to distribute this gas mixture in a homogeneous manner over the entire cross-section of the oxychlorination zone.

The entire disclosures of all applications, patents and publications, cited herein and of corresponding French application Ser. No. 12/01888, filed Jul. 4, 2012 are incorporated by reference herein.

1. Reactor for continuous regeneration of catalyst grains, composed of a chamber (2) that comprises an oxychlorination zone (72) superposed on a calcination zone (75) that is equipped with a pipe for introducing calcination gas, characterized in that the oxychlorination zone (72) is separated by a height H from the calcination zone (75) by a mixing zone (82) that extends over said height H, with the mixing zone (82) being covered by a tray (80) through which a number of tubes (81) pass, making it possible for catalyst grains to pass from the oxychlorination zone (72) into the calcination zone (75), with the tubes (81) extending at least over the height H of the mixing zone, the lower surface (77) of the mixing zone (82) being gas-permeable, with the reactor comprising a pipe for injecting oxychlorination gas (73) emptying into the mixing zone (82), and the tray (80) comprising a number of openings (83) that are permeable to gas and impermeable to catalyst grains.

2. Reactor according to claim 1, wherein each of the openings (83) is selected from among a bubble cap, a perforated plate, and a grid.

3. Reactor according to claim 2, wherein each of the openings (83) consists of a vertical tubular grid (84), with the lower end of the tubular grid communicating with the mixing zone, and the upper end of the grid being blocked by a roof (85).

4. Reactor according to claim 3, wherein the roof (85) is a cone whose peak is directed upward.

5. Reactor according to claim 1, wherein the pipe (73) for injecting oxychlorination gas empties into the mixing zone (80) at the wall of the chamber (2) of the reactor.

6. Reactor according to claim 5, wherein the pipe (73) for injecting oxychlorination gas empties into the middle of the mixing zone (80).

7. Reactor according to claim 5, wherein the mixing zone (80) comprises at least one deflecting plate (89) arranged in front of the pipe for injecting oxychlorination gas.

8. Reactor according to claim 1, wherein the lower surface (77) of the mixing zone comprises a gas-permeable plate.

9. Reactor according to claim 8, wherein the tubes (81) are integral with the tray (80) and the gas-permeable plate.

10. A method for catalytic reforming of a hydrocarbon feedstock, wherein, in a reactor according to claim 1,
A stream of catalyst grains is introduced at the top of the oxychlorination zone,
A stream of calcination gas is introduced via the pipe for introducing calcination gas,
A stream of oxychlorination gas is introduced via the pipe for injecting oxychlorination gas,
A stream of gas is evacuated at the top of the oxychlorination zone,
A stream of catalyst grains is evacuated at the bottom of the calcination zone.

11. Method according to claim 10, wherein the catalyst grains comprise platinum that is deposited on a porous substrate, the calcination gas stream comprises air or depleted air and is at a temperature of between 400° C. and 550° C., and the oxychlorination gas stream comprises a chlorine-containing compound and is at a temperature of between 350° C. and 550° C.

12. Process for obtaining a reactor according to claim 1, wherein a remodeling of an existing reactor is carried out by replacing the old system for injecting oxychlorination gas by said mixing zone.
